(19) United States
(12) Patent Application Publication
(10) Pub. No.: US 2020/0170256 A1
(43) Pub. Date: Jun. 4, 2020

(54) Amonia Based Piscicide

(71) Applicant: David Lance Ward, Flagstaff, AZ (US)

(72) Inventor: David Lance Ward, Flagstaff, AZ (US)

(21) Appl. No.: 16/205,226

(22) Filed: Nov. 30, 2018

(51) Int. Cl. A01N 59/02

(52) U.S. Cl. CPC A01N 59/02

(57) ABSTRACT

The invention is an ammonia-based piscicide compound, method of use and dispenser apparatus which enables eradication of invasive gill-breathing species in a bounded body of water and which prepares the area for subsequent repopulation by native species or other desirable species. The claimed compositions and method of use enable cost effective, large-scale eradication of gill-breathing aquatic species in water conveyance systems, bounded ponds and tributaries.

### FIELD OF INVENTION

This invention relates to the field of piscicide for control of invasive aquatic species and more specifically to ammonia-based piscicide

### BACKGROUND OF THE INVENTION

The U.S. Geological Survey (USGS) Ecosystems Mission Area, the biological research arm of the Department of the Interior (DOI), conducts advanced scientific research to conserve the Earth's land and water resources. The role of the USGS is critical in providing states and wildlife management agencies with objective scientific data and technological solutions to protect U.S. lakes, rivers and tributaries from the effects of invasive species such as Asian Carp. Asian Carp are prohibited invasive species which cause irreversible ecosystem damage, that can potentially render the environment inhospitable to the $7 billion per year fishing industry that significantly contributes to the nation's gross domestic product (GDP). Introduction of Asian Carp into an ecosystem can eradicate native fish populations in a matter of years.

Asian carp have become the dominant species in the Illinois River, which connects the Mississippi River to Lake Michigan. If Asian Carp enter the Great Lakes, the species is expected to reach 31 states.

Since 2010, the chemical compound Rotenone has been used to combat the spread of invasive aquatic species such as Asian Carp, despite the associated increase in the risk of Parkinson's Disease (PD) and other neurological diseases.

Currently, rotenone is the only commercially available piscicide. However, its use is undergoing increased scrutiny in many states because of new data linking occupational Rotenone use in agricultural settings to Parkinson's disease.

In 2011, researchers at the National Institutes of Health conducted a study of 31 different piscicides and determined that rotenone is associated with Parkinson's disease. Of all 31 tested piscicides, rotenone was found to play the greatest role in inhibiting mitochondrial complex I, which has been linked to the dopaminergic neuron death associated with Parkinson's disease, and potentially other neurological disorders.

Ammonia is well known in the art for its toxicity to fish, but it is not used for fish management because liquid or anhydrous ammonia also poses significant human health risks. (See An evaluation of liquid ammonia (ammonium hydroxide) as a candidate piscicide by Ward, D. L. et. al, 2013). Ammonia is also not currently used as a tool for fish management because effective amounts exceed maximum concentration limits permissible by the US Environmental Protection Agency.

There is an unmet need for a chemical substance that will kill nuisance aquatic species and that dissipates naturally in the environment which is not harmful to humans or other non-targeted species.

### SUMMARY OF THE INVENTION

In various embodiments, the invention is a piscicide dispensing apparatus and compound which includes effective amounts of ammonium chloride, sodium carbonate, and sodium sulfite for removing invasive aquatic species. When used in accordance with the claimed method, ammonia concentrations reach levels that are toxic to aquatic animals, to allow eradication of invasive species within a bounded area.

The claimed piscicide apparatus, compound and method of use enables cost effective, large-scale treatments of water conveyance structures, bounded ponds and tributaries to eradicate invasive species and prepare an affected area for subsequent repopulation by native species or desirable species.

### BRIEF DESCRIPTION OF THE DRAWINGS

FIG. 1A and FIG. 1B illustrate two alternate embodiments of an ammonia-based piscicide which enables eradication of invasive, gill-breathing species in a bounded area and which prepares the area for subsequent repopulation by native species or desirable species.

FIG. 2 illustrates an exemplary interaction of temperature and pH levels relevant to producing an ammonia-based piscicide that is lethal to gill-breathing organisms.

FIG. 3 is a table which identifies exemplary gill-breathing organisms which are eradicated by using various embodiments of an ammonia-based piscicide.

FIG. 4 illustrates test data documenting a 600-1500% reduction in the effective amount of the active ingredient, ammonium chloride, achieved by alternative embodiments of an ammonia-based pisticide.

FIG. 4 illustrates an exemplary method for using an ammonia-based piscicide for eradicating invasive gill breathing species in a bounded area which enables complete restoration of an aquatic environment.

### TERMS OF ART

As used herein, the term “diffusion interval” means the interval of time beginning when a piscicide is released into a bounded area and ending when the piscicide achieves a uniform concentration throughout the bounded area.

As used herein the term “effective amount” refers to an amount of a chemical substance that is lethal to gill breathing species, when present alone or in conjunction with other chemical substances. An effective amount may vary dependent upon temperature, pH level or the presence and amount of other chemical substances.

### DETAILED DESCRIPTION OF THE INVENTION

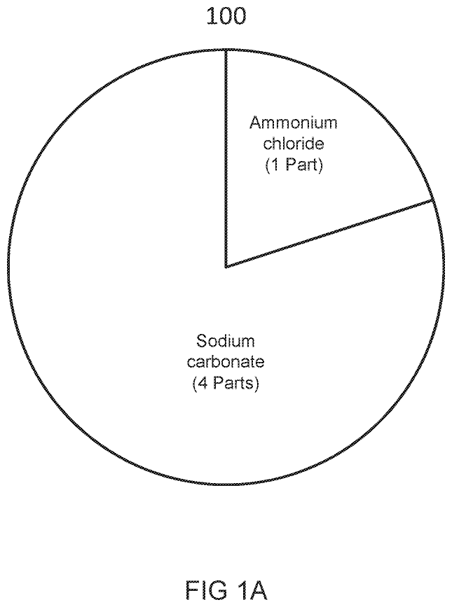

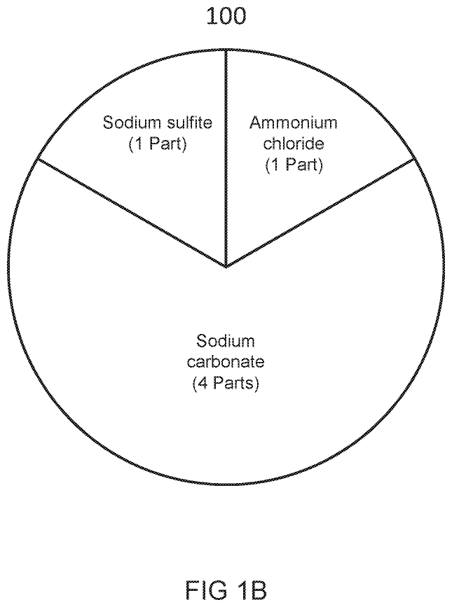

FIG. 1A and FIG. 1B illustrate two alternate embodiments of an ammonia-based piscicide which enables eradication of invasive, gill-breathing species in a bounded area and which prepares the area for subsequent repopulation by native species or desirable species.

In both embodiments, the invention utilizes the combination of ammonium chloride and sodium carbonate to remove invasive, gill-breathing aquatic species. In both embodiments, ammonia-based piscicide 100 kills aquatic species without making them unsafe for human consumption.

FIG. 1a illustrates an exemplary embodiment of ammonia-based piscicide 100 which includes 1-part ammonium chloride and 4-parts sodium carbonate, by weight.

The ammonium chloride releases ammonia into the water. Gills transport ammonia directly into an animal's blood stream, killing gill-breathing aquatic species. Organisms without gills remain unaffected.

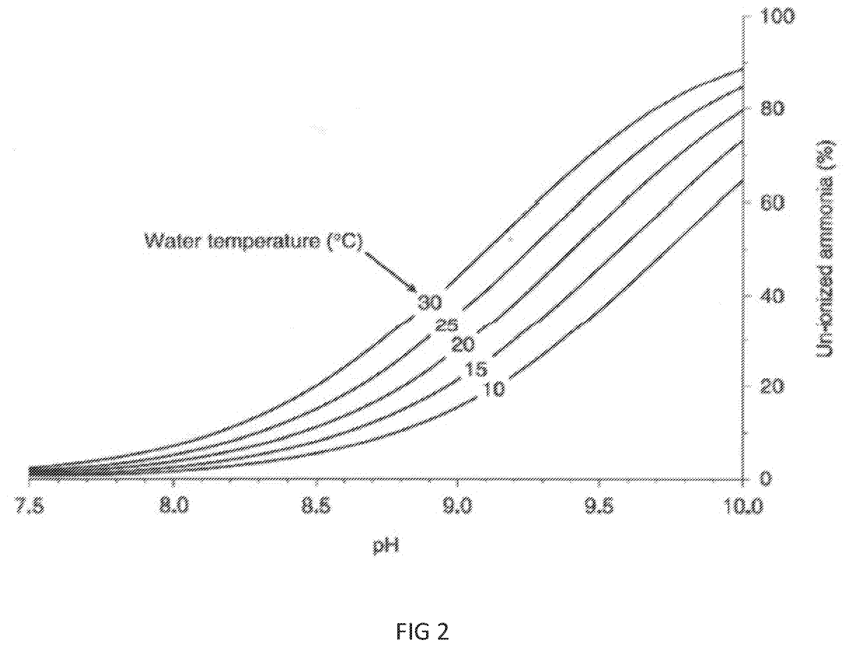

The sodium carbonate increases the pH of the water to increase the percentage of the ammonia that exists in the toxic, un-ionized form (see FIG. 2). This reduces the amount of ammonium chloride and time required to effectively kill aquatic nuisance species and also subsequently reduces the amount of time it takes for natural bacteria in the environment to neutralize the ammonia following treatment.

In one exemplary embodiment, 0.1 g/gallon ammonium chloride combined with 0.4 g/gallons of sodium carbonate achieves the approximate effect of 0.6-0.8 grams of ammonium chloride alone per gallon. This represents a 600 to 800% reduction in the effective amount of ammonium chloride.

In various embodiments, the cost of the piscicide is also reduced. Ammonium chloride is several times the cost of sodium carbonate. The cost of the piscicide is reduced by decreasing the effective amount of ammonium chloride being used.

The introduction of sodium carbonate reduces the amount of ammonium chloride released into a bounded are of the environment and reduces the time necessary to safely begin repopulation of the bounded area.

FIG. 1B illustrates an alternative embodiment for targeting more difficultto-kill species, that are less sensitive to ammonia toxicity, including crayfish and catfish. The embodiment illustrated in FIG. 1B further includes 1-part sodium sulfite, which reduces the dissolved oxygen concentration of the water to increase the animal's respiration rate and subsequent diffusion of ammonia through the gills.

The addition of sodium sulfite reduces the effective amount of ammonium chloride needed by 1200 to 1600% per gallon of treated water.

In both embodiments, the ammonium chloride is in a solid form, which may include a powder, pellet, or granulated form. Ammonium chloride, in a solid form, such as a powder, does not release noxious fumes like liquid or anhydrous ammonia, but dissolves readily in water to produce ammonia. The use of a solid powdered or granulated form is critical to avoid harmful effects to humans when processing and handling ammonia-based piscicide 100.

In various embodiments, ammonia-based piscicide 100 is in a powder, pellet, briquette or puck form. The powder form has more surface area than a pellet, briquette, or puck form and dissolves more quickly in water.

In various embodiments, delivery of ammonia-based piscicide 100 is accomplished using moisture-resistant packaging. This prevents premature dissolution and activation of ammonia-based piscicide 100, which can result in noxious fumes and potential injury to humans. The moisture resistant packaging is opened over the body of water and the ammonia-based piscicide 100 is poured directly into the body of water. In alternate embodiments, the composition may be delivered to the water in a packet made of water soluble paper, wherein the water-soluble paper dissolves upon contact with the water. The water-soluble paper packet should be kept dry until it reaches the body of water.

In various embodiments, ammonia-based piscicide 100 sinks to the bottom of a lake or pond where most of the fish are located and dissolves, releasing the ammonia where the fish are located. The high solubility of ammonia in water prevents the need for any mixing, which is a substantial advantage over other piscicidal formulations like rotenone which require extensive personnel to disperse the chemical and mix it to achieve an effective fish kill.

In both exemplary embodiments shown, 0.5 to 0.6 grams of ammonia-based piscicide 100 treats approximately one gallon of water in a body of water with natural boundaries. In the embodiment shown in FIG. 1A, ammonia-based piscicide 100 is a combination of approximately 0.1 grams of ammonium chloride, and 0.4 grams of sodium carbonate to treat one gallon of water. In the embodiment shown in FIG. 1B, ammoniabased piscicide 100 is a combination of approximately 0.1 grams of sodium sulfite, 0.1 grams of ammonium chloride, and 0.4 grams of sodium carbonate to treat one gallon of water.

In the exemplary embodiment shown, the following chemical reaction equations support the estimated amounts of piscicide 100 needed to treat a given volume of water to achieve the target ammonia concentration. Ammonium chloride induces the following chemical reactions when added to water: NH₄Cl(s)→NH₄⁺(aq)+Cl⁻(aq) and NH₄⁺(aq)+OH⁻(aq)→NH₃(aq)+H₂O. Sodium carbonate induces the following reactions when added to water: Na₂CO₃(s)→2Na⁺(aq)+CO₃²⁻(aq) and CO₃⁻² aq)+H₂O→HCO₃⁻(aq)+OH⁻(aq). Sodium sulfite induces the following reactions when added to water Na₂SO₃(s)→2Na⁺(aq)+S0₃²⁻(aq) and 2SO₃²⁻(aq)+O₂(g)→2SO₄²⁻.

In various embodiments, treating a moving stream of water will require continuous addition of ammonia-based piscicide 100, at a rate determined by the user to be lethal to the target species. Ammonia-based piscicide 100 can be mixed in a dispenser or barrel and distributed into a moving stream of water at a constant rate.

The required amount of ammonia-based piscicide 100 may vary, depending on the geographic location and water chemistry of the body of water to be treated. Ammonia-based piscicide 100 diffuses rapidly in water and does not require mixing. Higher water temperatures will increase the rate of diffusion.

In various embodiments, 0.5 grams of ammonia-based piscicide 100 per gallon creates a total ammonia level (nitrogen level) in excess of 6 parts per million (ppm). At a high pH (see FIG. 2), an ammonia level above 6 ppm produces an un-ionized ammonia level that is lethal to gill-breathing organisms within 4 hours. Lower ammonia levels of 2 ppm can be lethal to gill-breathing organisms but may require longer treatment times to kill the organisms.

In various embodiments, the volume of the body of water may be difficult to calculate. Following delivery of the ammonia-based piscicide 100, the user may complete a water quality test known in the art to check the ammonia level after a typical diffusion interval of 1-24 hours. In various embodiments, the water quality test is conducted at multiple locations on the perimeter of the body of water.

If test result reveals that the level of ammonia is lower than 6 ppm, the user can add more of ammonia-based piscicide 100. Ammonia levels of 2 ppm are lethal but require a longer time to kill gill-breathing organisms. In various embodiments, the test result can help approximate an additional quantity of ammonia-based piscicide 100 that is required to reach target concentrations. The user calculates said additional amount by setting up a proportion where the amount of piscicide previously added is divided by the observed total ammonia concentration. That calculated ratio is equal to the total amount of piscicide needed divided by the desired target concentration. Subtracting the amount of piscicide previously added gives the user the additional quantity of piscicide needed to reach the target concentration.

In an alternative embodiment, the user multiplies the originally estimated volume of water by the concentration of ammonia result obtained from the test and divides the result by the target ammonia concentration. The result is a more accurate estimate of the volume of water. Then, the user can calculate the additional amount of ammonia based piscicide 100 to add by subtracting the originally estimated volume of water from the more accurate estimate of the volume of water and multiplying the result by 0.5 grams per gallon.

In various embodiments, aquatic animals killed by ammonia-based piscicide 100 may be collected and disposed of or eaten. In alternative embodiments, aquatic animals killed by ammonia-based piscicide 100 may be left in the body of water to decompose.

In both embodiments, ammonia-based piscicide 100 is naturally neutralized after treatment, without killing non-target species or requiring a detoxifying step after treatment. This is an advantage over rotenone, which can require the addition of potassium permanganate or chlorine after treatment. Adding these chemicals requires thorough mixing, is costly, and is harmful to non-target species.

After treatment with ammonia-based piscicide 100, natural bacteria in the environment quickly detoxify any remaining ammonia by converting it first to nitrite and then to nitrate which is utilized by plants, leaving no harmful residues. In various embodiments, this process is typically complete within 3 weeks of treatment (depending on water temperature) and the pH in well buffered systems typically returns to baseline conditions within a few days after treatment. After the ammonia and pH levels return to the baseline conditions that existed before the treatment, non-invasive fish can be reintroduced to the body of water.

Sodium carbonate is baking soda that has been heated, so it is relatively benign and there is little concern about adding it to natural bodies of water. In the sulfite embodiment, the sulfate concentrations that are produced (20 mg/l) are well below typical safe limits for domestic water supplies (250 mg/l).

In various embodiments, the ammonium chloride can be replaced with other solid, ammonia-forming compounds such as ammonium sulfate or ammonium nitrate. The sodium carbonate can be replaced by other chemicals that increase pH when dissolved in water, like sodium bicarbonate or sodium hydroxide.

The exemplary compounds illustrated in FIGS. 1a and 1b have significant advantages over the use of rotenone. These compounds do not require thorough mixing, whereas rotenone does. Rotenone will detoxify in 1 to 4 weeks, depending on the rate of chemical application, water temperature and other environmental factors, but detoxification of rotenone may also require the use of potassium permanganate or chlorine, adding considerable cost. These substances can remain in residual amounts that are harmful to non-targeted species. In contrast, ammonia-based piscicide 100 is neutralized naturally with no need to add additional chemicals for detoxification before repopulating a bounded area with desired animal species.

The exemplary compounds illustrated in FIGS. 1a and 1b do not introduce compounds to the aquatic environment which are not naturally present. The exemplary compounds are substances which are naturally present as waste products of metabolism or are present naturally in the environment.

Testing for the presence of the exemplary compounds illustrated in FIGS. 1a and 1b can be accomplished in situ and real time. In contrast, costly laboratory testing is legally required to detect residual rotenone.

FIG. 2 illustrates an exemplary interaction of temperature and pH levels relevant to producing ammonia-based piscicide 100 that is lethal to gill breathing organisms.

When ammonia is dissolved in water it takes one of two forms, an ionized form which is toxic and an un-ionized form which is very toxic to aquatic organisms. The percentage of ammonia present in each form is dependent on the pH of the water. Water with increased pH levels requires much less ammonia to effectively kill aquatic nuisance species because the amount of unionized ammonia increases with increasing pH. Sodium carbonate in ammonia-based piscicide 100 increases the pH in the water. Increasing the pH of the water decreases the cost and the amount of ammonia that needs to be used.

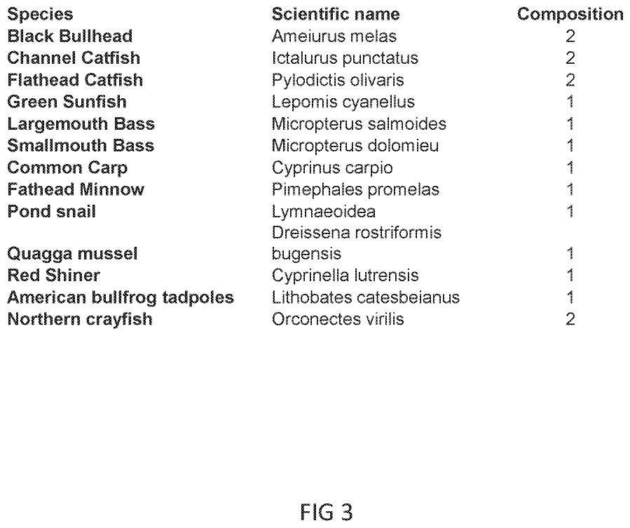

FIG. 3 is a table which identifies exemplary gill-breathing organisms which are eradicated by using various embodiments of ammonia-based piscicide 100.

The table in FIG. 3 shows common and scientific names of exemplary invasive species that are killed by two embodiments of ammonia-based piscicide 100. Composition 1 is the embodiment shown in FIG. 1B which includes ammonium chloride and sodium carbonate. Composition 2 is the embodiment shown in FIG. 1B which includes ammonium chloride, sodium carbonate, and sodium sulfite.

In various embodiments, the invention may be used to target specific invasive gill-breathing aquatic species, such as aquatic invasive snails, mollusks, and fish.

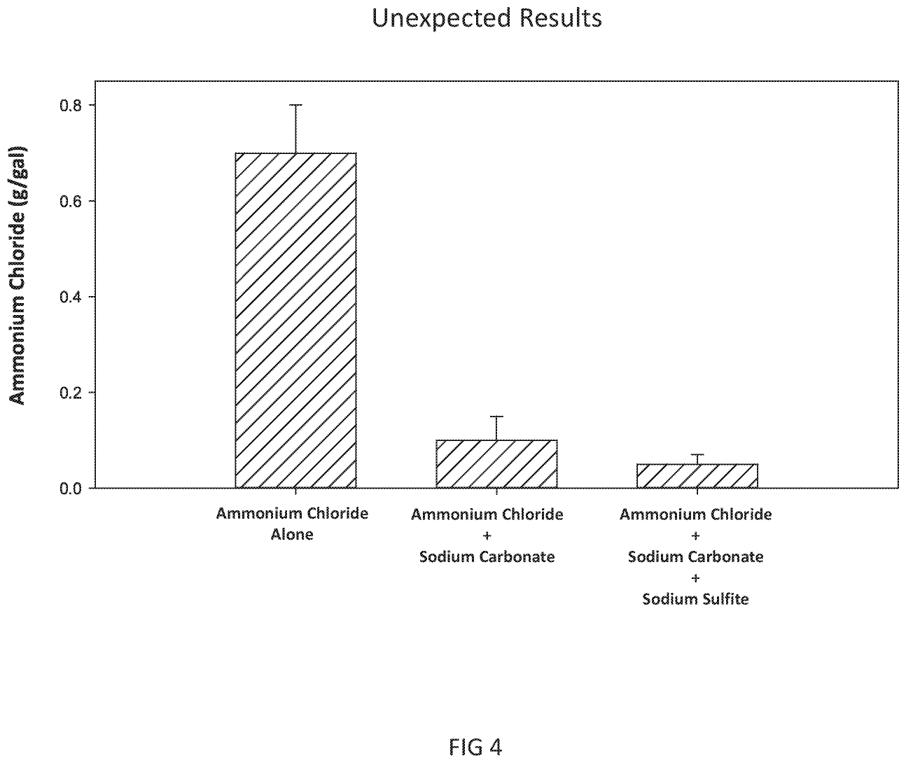

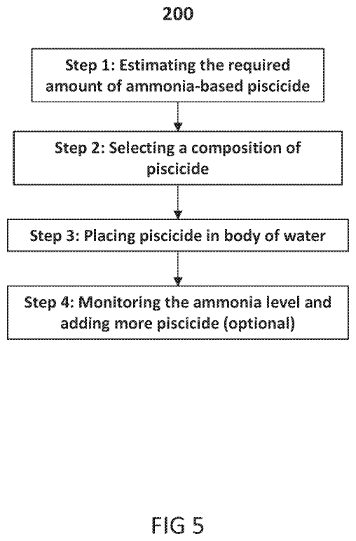

FIG. 4 illustrates test data documenting a 600-1500% reduction in the effective amount of the active ingredient, ammonium chloride, achieved by alternative embodiments of an ammonia-based pisticide.

During each replicate trial, ten fathead minnows were exposed to the pisticide over a four hour period in 100-gallon laboratory tanks at 20° C. FIG. 4 compares the effective amount of ammonium chloride when used alone to the alternative formulations of the piscicide. Due to the reduction in the effective amount of ammonium chloride, the amount of time needed for natural bacteria in the environment to neutralize the ammonia prior to restocking is substantially reduced.

FIG. 5 illustrates an exemplary method 200 for using an ammonia-based piscicide for eradicating invasive gill breathing species in a bounded area which enables complete restoration of an aquatic environment.

Step 1 is the step of calculating the required amount of ammonia-based piscicide 100.

Step one includes estimating the volume of water within natural boundaries and multiplying the gallons of water by 0.5 or 0.6 grams. The result of this calculation is an estimate of the minimum effective quantity of ammonia-based piscicide 100 to be added to the body of water.

Step 2 is the optional step of selecting a composition of ammonia-based piscicide 100.

In various embodiments, the user will determine whether the body of water requires composition 1 (0.5 grams) or 2 (0.6 grams) of ammonia-based piscicide 100 based on the target species. Composition 1 includes 1-part ammonium chloride and 4 parts sodium carbonate by weight. Composition 2 includes 1-part ammonium chloride, 1-part sodium sulfite and 4-parts sodium carbonate by weight.

Step 3 is the step of placing ammonia-based piscicide 100 in the body of water to be treated.

Ammonia-based piscicide 100 can be introduced into the body of water and will dissipate, without the need for mixing.

Step 4 is the optional step of monitoring the ammonia level and adding additional ammonia-based piscicide 100.

After placing ammonia-based piscicide 100 into the body of water, the treated water ammonia level and/or pH level can be tested by any kit known in the art, including commercially available chemically sensitive paper (color-changing test strips).

If the amount of ammonia is less than 6 ppm, the additional ammonia-based piscicide 100 may be placed in the body of water. Ammonia levels of 2 ppm are lethal, but effective killing of gill-breathing aquatic species will require more time.

What is claimed is:

1. A piscicide compound comprised of:
an effective amount of ammonium chloride to induce the following reactions when added to water;
NH₄Cl(s)→NH₄⁺(aq)+Cl⁻(aq) and NH₄⁺(aq)+OH⁻(aq)→NH₃(aq)+H₂O;
and an effective amount of sodium carbonate to induce the following reactions when added to water Na₂CO₃(s)→2Na⁺(aq)+CO₃²⁻(aq) and CO₃⁻²aq)+H₂O→HCO₃⁻(aq)+OH⁻(aq).

2. The piscicide compound of claim 1, wherein said effective amount of said ammonium chloride is an amount that is 600 to 800 percent less than the effective amount of ammonium chloride alone, per gallon of treated water.

3. The piscicide compound of claim 1, which is further comprised of an effective amount of sodium sulfite to induce the following reactions when added to water Na2SO3(s)□2Na+(aq)+SO32−(aq) and 2SO32−(aq)+O2(g)□2SO42−.

4. The piscicide compound of claim 3, wherein said effective amount of sodium sulfite is equal to said effective amount of ammonium chloride.

5. The piscicide compound of claim 3 wherein said effective amount of said ammonium chloride is an amount that is 1200 to 1600 percent less than the effective amount of ammonium chloride alone, per gallon of treated water

6. Piscicide compound of claim 3, wherein said effective amount of sodium sulfite is approximately 0.1 grams per gallon of treated water, said effective amount of ammonium chloride is approximately 0.1 grams per gallon of treated water and said effective amount of sodium carbonate is approximately 0.4 grams per gallon of treated water.

7. The piscicide compound of claim 1, wherein said effective amount of ammonium chloride is 0.1 grams per gallon of treated water and said effective amount of sodium carbonate is 0.4 grams per gallon of treated water.

8. The piscicide of claim 1, wherein said effective amount of said ammonium chloride is equal to one-fourth of said effective amount of said sodium carbonate.

9. The piscicide compound of claim 1, wherein said piscicide compound is combined with water at a ratio of 0.5 grams per gallon.

10. A method for eradicating invasive species using an ammonia-based piscicide, comprised of the steps of:
estimating a volume of water in a bounded area; combining an effective amount of ammonium chloride with an effective amount of sodium carbonate to form an ammonia-based piscicide; and dispersing said ammonia-based piscicide within said volume of water to induce the following reactions NH₄Cl(s)→NH₄⁺(aq)+Cl⁻(aq), NH₄⁺(aq)+OH⁻(aq)→NH₃(aq)+H₂O, Na₂CO₃(s)→2Na⁺(aq)+CO₃²⁻(aq), and CO₃⁻²aq)+H₂O→HCO₃⁻(aq)+OH⁻(aq) to raise the concentration of total ammonia to a target concentration above 2 ppm.

11. The method of claim 10, wherein an effective amount of ammonium chloride is reduced by 600 to 800 percent, per gallon treated water.

12. The method of claim 10, which further includes the step of combining an effective amount of sodium sulfite with said effective amount of ammonium chloride and said effective amount of sodium carbonate to induce the following reactions when added to said volume of water Na2SO3(s) 2Na+(aq)+SO32−(aq) and 2SO32(aq)+O2(g)□ 2SO42−to reach said target concentration.

13. The method of claim 10, said effective amount of said ammonium chloride is an amount that is 1200 to 1600 percent less less than the effective amount of ammonium chloride alone, per gallon of treated water

14. The method of claim 11, which further includes the step of dispersing 0.5 grams of said ammonia-based piscicide per gallon of water within said bounded area to reach said target concentration.

15. The method of claim 10, which further includes the step of measuring the concentration of ammonia at least two distal locations within said bounded area.

16. The method of claim 10, which further includes the steps of testing the water in said bounded area to determine if said target concentration has been achieved and adding an additional amount of said ammonia-based piscicide to achieve said target concentration.

17. The method of claim 16, which further includes the steps of calculating said additional amount by multiplying the previously added amount of said ammoniabased piscicide by a ratio equal to the target concentration over the current concentration and subtracting said previously added amount of said ammoniabased piscicide.

18. The method of claim 17, which further includes the step of iteratively measuring said concentration of ammonia and calculating said additional amount of said ammonia-based piscicide to be added to achieve said target concentration.

19. A method for eradicating invasive species and repopulating a bounded aquatic environment comprised of the steps of:
estimating the volume of water contained with said bounded aquatic environment;
mixing 1 part of solid state ammonium chloride with 4 parts solid state sodium carbonate to form a piscicide; dispersing a sufficient quantity of said piscicide in said bounded aquatic environment to induce the following reactions NH₄Cl(s)→NH₄+(aq)+Cl⁻(aq), NH₄⁺(aq)+OH⁻(aq)→NH₃(aq)→H₂O, Na₂CO₃(s)→2Na⁺(aq)+CO₃²⁻(aq) and CO₃⁻²aq)+H₂O→HCO₃⁻(aq)+OH⁻(aq) to increase the concentration of ammonia in said volume of water to a target concentration to eradicate said invasive species; waiting a sufficient amount of time to reduce said concentration of ammonia to below 2 ppm; and repopulating said bounded aquatic environment with desirable species.

20. The method of claim 19, wherein said sufficient amount of time is approximately seven days.
